(19) United States
(12) Patent Application Publication
(10) Pub. No.: US 2018/0170150 A1
(43) Pub. Date: Jun. 21, 2018

(54) DEVICE AND METHOD FOR AIR-CONDITIONING A MOTOR VEHICLE

(71) Applicant: CONTINENTAL AUTOMOTIVE GMBH, Hannover (DE)

(72) Inventor: Christoph Baumgärtner, Regenstauf (DE)

(73) Assignee: CONTINENTAL AUTOMOTIVE GMBH, Hannover (DE)

(21) Appl. No.: 15/895,064

(22) Filed: Feb. 13, 2018

Related U.S. Application Data
(63) Continuation of application No. PCT/EP2016/068849, filed on Aug. 8, 2016.

(30) Foreign Application Priority Data
Aug. 13, 2015 (DE) 10 2015 215 486.6

(51) Int. Cl. B60H 1/00; G01C 21/36

(52) U.S. Cl. CPC B60H 1/00771; B60H 1/00971; G01C 21/3691

(57) ABSTRACT

The present invention relates to a device for air conditioning a motor vehicle, wherein the device comprises: an interface apparatus which is configured to make available an evaluation of a surrounding area of the motor vehicle in the form of climatic ambient data from outside the motor vehicle and to transfer the ambient data to a backend; an air conditioning apparatus which is configured to air condition at least part of a passenger compartment of the motor vehicle using a predetermined quantity of energy; and a control apparatus which is configured to determine an operating strategy for the air conditioning apparatus and to optimize the determined operating strategy on the basis of a profile, received from the backend of the climatic ambient data.

### CROSS-REFERENCE TO RELATED APPLICATIONS

This application claims the benefit of PCT Application PCT/EP2016/068849, filed Aug. 8, 2016, which claims priority to German Patent Application 10 2015 215 486.6, filed Aug. 13, 2015. The disclosures of the above applications are incorporated herein by reference.

### FIELD OF THE INVENTION

The present invention relates to air conditioning systems and air conditioning apparatuses for motor vehicles. In particular, the present invention relates to a device for air conditioning a motor vehicle, to a backend for optimizing an operating strategy for air conditioning a motor vehicle and to a method for air conditioning a motor vehicle.

### BACKGROUND OF THE INVENTION

In motor vehicles, the air conditioning system is operated only with local information, and the air conditioning system is usually calibrated to different use scenarios of the motor vehicle during the development phase of the motor vehicle, involving a large amount of expenditure and high costs.

Furthermore, in the air conditioning systems used in the motor vehicle the adjustment is subjective, since not every user finds room climate conditions, such as for example moisture or temperature, pleasant in the same way. As a result of this subjective adjustment of the air conditioning system, an increased expenditure on testing and calibration is necessary for the air conditioning system during the development phase of the motor vehicle.

### SUMMARY OF THE INVENTION

An object of the present invention is to make available an improved device, an improved backend and an improved method for air conditioning a motor vehicle.

This object is achieved by the subject matters of the independent patent claims. Embodiments and developments are found in the dependent patent claims, the description and the figures of the drawings.

A first aspect of the present invention relates to a device for air conditioning a motor vehicle, wherein the device comprises: an interface apparatus which is configured to make available an evaluation of a surrounding area of the motor vehicle in the form of climatic ambient data from outside the motor vehicle and to transfer the ambient data to a backend; an air conditioning apparatus which is configured to air condition at least part of a passenger compartment of a motor vehicle using a pre-determined quantity of energy; and a control apparatus which is configured to determine an operating strategy for the air conditioning apparatus and to optimize the determined operating strategy on the basis of a profile, received from the backend of the climatic ambient data.

In other words, by means of the precise position of the vehicle it is possible to generate an evaluation of the surrounding area with respect to the prevailing climate—weather conditions such as, for example, the temperature, air pressure, wind strength, solar radiation or meteorological parameters—using the climatic ambient data, and this ambient data is made available to the backend and/or the motor vehicle.

In this context, the backend is designed to be used as an interface for the motor vehicle in a data network, for example the Internet. The backend may assume open-loop and closed-loop control functions here and may actuate, for example, an air conditioning apparatus of the motor vehicle and/or make available an optimized operating strategy to the air conditioning apparatus. In this context, the optimization is carried out energetically or with respect to the comfort or with respect to a personalization process. The backend may use information from a plurality of motor vehicles, at least two motor vehicles, here, and may transfer climatic ambient data or test data and calibration data from at least one further motor vehicle to the motor vehicle which is sending the request.

In this context, the backend is designed, for example, to determine a profile of the climate-relevant data by using further information from weather services, further vehicles or a planned route.

On the basis of the climate-relevant data, a proposal is generated for the driver, in order, for example, to make available an optimized operating strategy which is personalized, that is to say is adapted to the driver. In addition, the optimized operating strategy is determined, in terms of energetic criteria, as a function of a selected route of the motor vehicle, and the consumption of energy which is required to air condition the passenger compartment of the motor vehicle is reduced.

In other words, a personalized operating strategy is made available for the air conditioning apparatus of the motor vehicle, and in addition an operating strategy which is optimized in terms of comfort or energy is made available for air conditioning the motor vehicle for selected situations or routes.

According to a further, second aspect, the present invention relates to a backend for optimizing an operating strategy for air conditioning a motor vehicle, wherein the backend comprises: a backend interface apparatus which is configured to receive climatic ambient data from at least two motor vehicles; a computer apparatus which is configured to determine a profile of the climatic ambient data for each of the at least two motor vehicles; and wherein the backend interface apparatus is configured to transfer the determined profile of the climatic ambient data to each of the at least two motor vehicles.

In this context, the term profile of the climatic ambient data may comprise a time profile and/or a spatial profile. In other words, the profile is determined as a function of the time and/or as a function of a spatial coordinate, for example the route of a motor vehicle of the at least two motor vehicles. The profile of the climatic ambient data is assigned here in each case to a motor vehicle, for example on the basis of the respective route.

According to a further, third aspect of the present invention, a method for air conditioning a motor vehicle is provided, wherein the method comprises the following steps: making available an evaluation of a surrounding area of the motor vehicle in the form of climatic ambient data from outside the motor vehicle with the aid of an interface apparatus and transferring the evaluation to a backend; air conditioning at least part of a passenger compartment of the motor vehicle using a predetermined quantity of energy with the aid of an air conditioning apparatus; and determining an operating strategy for the air conditioning apparatus and optimizing the operating strategy for the air conditioning apparatus on the basis of a profile, received from the backend, of the climatic ambient data with the aid of a control apparatus.

Advantageous configurations of the present invention are characterized in the dependent claims.

In one advantageous embodiment of the present invention, there is provision that the control apparatus is configured to optimize the operating strategy for the air conditioning apparatus by minimizing the predetermined quantity of energy.

This advantageously permits an absolute minimum to be achieved with respect to the consumption of energy or the overall consumption of energy for the operation of the air conditioning apparatus.

In a further, advantageous embodiment of the present invention there is provision that the interface apparatus is configured, to make available as the climatic ambient data, an air temperature, a ground temperature, an air humidity, an intensity of a solar radiation or a wind strength. This advantageously permits climatic ambient conditions to be acquired.

In a further, advantageous embodiment of the present invention there is provision that the control apparatus is configured to determine the operating strategy for the air conditioning apparatus as a function of a driver profile and to optimize the operating strategy for the air conditioning apparatus on the basis of the acquired climatic ambient data and the driver profile. This advantageously permits a personalized operating strategy to be made available.

In a further, advantageous embodiment of the present invention there is provision that the control apparatus is configured to determine the operating strategy for the air conditioning apparatus as a function of a comfort parameter and to optimize the operating strategy for the air conditioning apparatus on the basis of the acquired climatic ambient data and the comfort parameter. This advantageously permits an operating strategy which is optimized in terms of comfort or energy to be determined for specific situations or specific routes.

In a further, advantageous embodiment of the present invention there is provision that the computer apparatus is configured to determine the profile of the climatic ambient data as a time profile and/or as a spatial profile. This advantageously permits optimization of the energy and/or comfort for the operating strategy to be determined on the basis of the anticipated route or the anticipated travel time.

In a further, advantageous embodiment of the present invention there is provision that the computer apparatus is configured to determine the profile of the climatic ambient data on the basis of data from a weather service, or from a further motor vehicle or a navigation device. This advantageously permits the profile of the climatic ambient data to be adapted to the route profile.

In a further, advantageous embodiment of the present invention there is provision that the computer apparatus is configured to determine the profile of the climatic ambient data on the basis of a route of the motor vehicle.

The described embodiments and developments may be combined with one another as desired.

Further possible embodiments, developments and implementations of the present invention also comprise combinations, which have not been explicitly specified, of features of the present invention which have been described above or below with respect to the examplary embodiments.

The appended drawings are intended to convey further understanding of the embodiments of the present invention. The appended drawings illustrate embodiments and serve, in conjunction with the description, to clarify concepts of the present invention.

Other embodiments and many of the specified advantages become apparent in relation to the Figures of the drawings. The illustrated elements of the Figures of the drawings are not necessarily shown true to scale with respect to one another.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The invention is explained in detail below with reference to an exemplary embodiment in connection with the drawing. In the drawings:

FIG. 1 shows a schematic illustration of a device for air conditioning a motor vehicle according to an embodiment of the present invention;

FIG. 2 shows a schematic illustration of a backend for optimizing an operating strategy for air conditioning a motor vehicle according to an embodiment of the present invention;

FIG. 3 shows a schematic illustration of a backend for optimizing an operating strategy for air conditioning a motor vehicle; and

FIG. 4 shows a schematic illustration of a flowchart of a method for air conditioning a motor vehicle according to an embodiment of the present invention.

### DETAILED DESCRIPTION OF THE PREFERRED EMBODIMENTS

The following description of the preferred embodiment(s) is merely exemplary in nature and is in no way intended to limit the invention, its application, or uses.

In the Figures of the drawings, identical reference symbols denote identical or functionally identical elements, assemblies, components or method steps, unless specified otherwise.

The motor vehicle or vehicle is, for example, a motor vehicle such as a car, bus or truck or else a rail vehicle, a ship, an aircraft, such as a helicopter or airplane, or for example a bicycle.

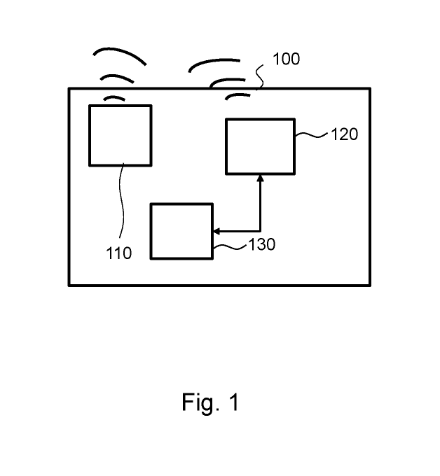

FIG. 1 shows a schematic illustration of a device for air conditioning a motor vehicle according to a further embodiment of the present invention.

A device 100 comprises, for example, an interface apparatus 110, an air conditioning apparatus 120 and a control apparatus 130.

The interface apparatus 110 is configured to make available an evaluation of a surrounding area of the motor vehicle in the form of climatic ambient data from outside the motor vehicle and to transfer the ambient data to a backend 200.

The interface apparatus 110 may be embodied as a Car2Backend communication data transmission apparatus and may make available wireless data transmission over a radio data network.

The wireless data transmission or the cableless reception of the climatic ambient data takes place by Bluetooth, WLAN (e.g. WLAN 802.11a/b/g/n or WLAN 802.11p), ZigBee or WiMax or else also cellular radio systems such as GPRS, UMTS or LTE. It is also possible to use other transmission protocols for the Car2Backend communication. The specified protocols provide the advantage of the standardization which has already taken place.

The air conditioning apparatus 120 is configured to air condition at least part of a passenger compartment of the motor vehicle using a predetermined quantity of energy. The air conditioning apparatus 120 is designed to condition the air with respect to air temperature and/or air humidity in the passenger compartment of the motor vehicle.

The control apparatus 130 is configured to determine an operating strategy for the air conditioning apparatus 120 and to optimize the determined operating strategy on the basis of a profile, received from the backend 200 of the climatic ambient data. The control apparatus 130 is supplied with the external temperature by a vehicle-side temperature sensor.

The control apparatus 130 may be configured, for example, to optimize the operating strategy for the air conditioning apparatus 120 by minimizing the predetermined quantity of energy. This advantageously makes it possible to determine an energetic minimum of the consumption of energy.

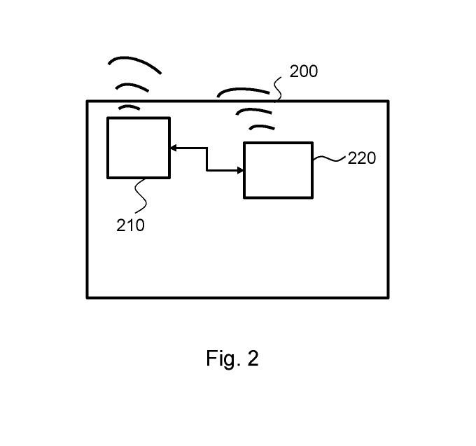

FIG. 2 shows a backend for optimizing an operating strategy for air conditioning a motor vehicle according to a further embodiment of the present invention. The backend 200 comprises an interface apparatus 210 and a computer apparatus 220.

The backend interface apparatus 210 of the backend 200 is configured to receive climatic ambient data from at least two motor vehicles.

The backend interface apparatus 210 may be embodied as a Car2Backend communication data transmission apparatus and may make available wireless data transmission over a radio data network.

The computer apparatus 220 is configured to determine a profile of the climatic ambient data for each of the at least two motor vehicles.

In this context, the computer apparatus 220 creates datasets by comparing a plurality of motor vehicles and therefore by means of a comparison with stored datasets of other motor vehicles determines the profile of the climatic ambient data and as a result make available an optimized operating strategy for the motor vehicle.

In addition, the backend interface apparatus 210 is configured to transfer the determined profile of the climatic ambient data in each case to the at least two motor vehicles. In other words, each motor vehicle receives its specific data for optimizing the respective operating strategy.

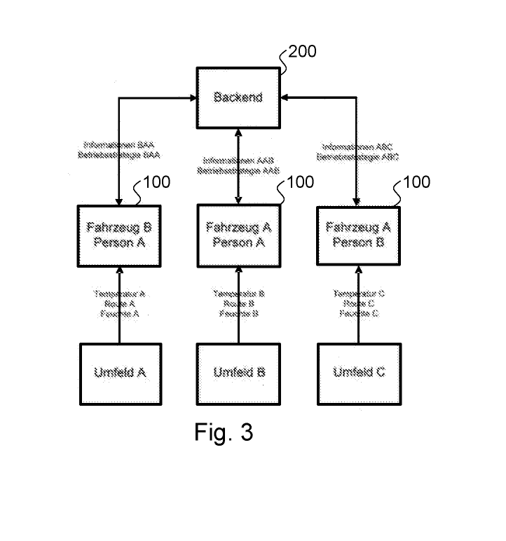

FIG. 3 shows a schematic illustration of a backend for optimizing an operating strategy for air conditioning a motor vehicle according to a further embodiment of the present invention.

A backend 200 is connected, for example, to a vehicle B and a vehicle A via a data radio link.

A person A is located in the vehicle B. The vehicle B is located in a surrounding area A. A device for air conditioning the motor vehicle determines the surrounding area A and determines in this context as climatic ambient data a temperature A and a moisture level A. The motor vehicle B is located here in a surrounding area A, as illustrated, for example, in FIG. 3.

In addition, in the example illustrated in FIG. 3 the motor vehicle B has a route A. The backend 200 receives the information BAA from the motor vehicle B here. An optimized operating strategy BAA is determined by the control apparatus 130 by means of the information transmitted from the backend 200 to the motor vehicle B or to the device 100 for air conditioning the motor vehicle B.

Furthermore, FIG. 3 shows a vehicle A in which a person A is located as a driver. The vehicle A is positioned in the surrounding area B and has a route B. An interface apparatus 110 of the device 100 of the vehicle A evaluates the surrounding area B and makes available climatic ambient data in the form of the temperature B and the moisture level B.

These are transferred from the interface apparatus 110 into the backend 200 in the form of the information AAB. An optimized operating strategy AAB is determined on the basis of the information transmitted from the backend to the vehicle A.

In addition, in FIG. 3 the vehicle A is illustrated this time with the person B as the driver. The vehicle A is located in a surrounding area C here.

In this context, the temperature C and moisture level C are determined as climatic ambient data. The interface apparatus 110 transfers the information ABC to the backend 200. An optimized operating strategy ABC is determined on the basis of the data transmitted from the backend 200 to the vehicle A with the person B.

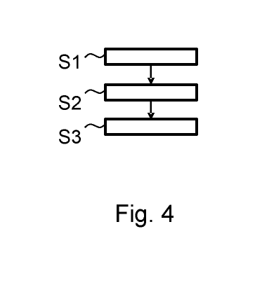

FIG. 4 shows a schematic illustration of a flowchart of a method for air conditioning a motor vehicle according to a further embodiment of the present invention.

The method illustrated in FIG. 4 comprises the following method steps here:

As a first step of the method, a process of making available S1 an evaluation of a surrounding area of the motor vehicle is carried out in the form of climatic ambient data from outside the motor vehicle with the aid of an interface apparatus 110 of the device 100 and transferring the evaluation to a backend 200.

As a second step of the method, the process of air conditioning S2 at least part of a passenger compartment of the motor vehicle is carried out using a predetermined quantity of energy with the aid of an air conditioning apparatus 120.

As a third step of the method, a process of determining S3 an operating strategy for the air conditioning apparatus 120 and optimizing the operating strategy for the air conditioning apparatus 120 is carried out on the basis of a profile, received from the backend 200, of the climatic ambient data with the aid of a control apparatus 130.

Although the present invention has been described above on the basis of preferred exemplary embodiments, it is not limited thereto but rather may be modified in a variety of ways. In particular, the present invention may be changed or modified in a variety of ways, without departing from the core of the invention.

In addition it is to be noted that “comprising” and “having” does not exclude any other elements or steps and “a” or “an” does not exclude a plurality.

In addition it is to be noted that features or steps which have been described with reference to one of the above exemplary embodiments may also be used in combination with other features or steps of other exemplary embodiments described above. Reference symbols in the claims are not to be considered to be limiting.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A device for air conditioning a motor vehicle, the device comprising:
a backend;
an interface apparatus which is configured to make available an evaluation of a surrounding area of the motor vehicle in the form of climatic ambient data from outside the motor vehicle and to transfer the ambient data to the backend;
an air conditioning apparatus which is configured to air condition at least part of a passenger compartment of the motor vehicle using a predetermined quantity of energy; and
a control apparatus which is configured to determine an operating strategy for the air conditioning apparatus and to optimize the determined operating strategy on the basis of a profile, received from the backend of the climatic ambient data.

2. The device of claim 1, wherein the control apparatus is configured to optimize the operating strategy for the air conditioning apparatus by minimizing the predetermined quantity of energy.

3. The device of claim 1, wherein the interface apparatus is configured to make available, as the climatic ambient data, an air temperature, a ground temperature, an air humidity value, an intensity of a solar radiation or a wind strength.

4. The device of claim 1, further comprising:
a driver profile;
wherein the control apparatus is configured to determine the operating strategy for the air conditioning apparatus as a function of the driver profile and to optimize the operating strategy for the air conditioning apparatus on the basis of the acquired climatic ambient data and the driver profile.

5. The device of claim 1, further comprising:
a comfort parameter;
wherein the control apparatus is configured to determine the operating strategy for the air conditioning apparatus as a function of the comfort parameter and to optimize the operating strategy for the air conditioning apparatus on the basis of the acquired climatic ambient data and the comfort parameter.

6. A backend for optimizing an operating strategy for air conditioning a motor vehicle, the backend comprising:
at least two motor vehicles;
a backend interface apparatus which is configured to receive climatic ambient data from the at least two motor vehicles;
a profile of the climatic ambient data; and
a computer apparatus which is configured to determine the profile of the climatic ambient data for each of the at least two motor vehicles;
wherein the backend interface apparatus is configured to transfer the determined profile of the climatic ambient data in each case to the at least two motor vehicles.

7. The backend of claim 6, wherein the computer apparatus is configured to determine the profile of the climatic ambient data as a time profile.

8. The backend of claim 6, wherein the computer apparatus is configured to determine the profile of the climatic ambient data as a spatial profile.

9. The backend of claim 6, wherein the computer apparatus is configured to determine the profile of the climatic ambient data on the basis of data from at least one of a weather service, a further motor vehicle or a navigation device.

10. The backend of claim 6, wherein the computer apparatus is configured to determine the profile of the climatic ambient data on the basis of a route of the at least two motor vehicles.

11. A method for air conditioning a motor vehicle, comprising the steps of:
providing a backend;
providing an interface apparatus;
providing an evaluation of a surrounding area of the motor vehicle in the form of climatic ambient data from outside the motor vehicle;
providing a passenger compartment of a motor vehicle; and
providing an air conditioning apparatus;
providing a profile of the climatic ambient data;
making available the evaluation of a surrounding area of the motor vehicle in the form of climatic ambient data from outside the motor vehicle with the aid of the interface apparatus;
transferring the evaluation to the backend;
air conditioning at least part of the passenger compartment of the motor vehicle using a predetermined quantity of energy with the aid of the air conditioning apparatus;
determining an operating strategy for the air conditioning apparatus and optimizing the operating strategy for the air conditioning apparatus on the basis of the profile, received from the backend, of the climatic ambient data with the aid of a control apparatus.
